(19) United States
(12) Patent Application Publication
(10) Pub. No.: US 2019/0163755 A1
(43) Pub. Date: May 30, 2019

(54) OPTIMIZED MANAGEMENT OF COURSE UNDERSTANDING

(71) Applicant: INTERNATIONAL BUSINESS MACHINES CORPORATION, Armonk, NY (US)

(72) Inventors: Georges-Henri Moll, Alpes Maritimes (FR); Xavier Nodet, Antibes (FR); Olivier Oudot, Vallauris (FR); Stephane Vincent, Alpes Maritimes (FR)

(21) Appl. No.: 15/825,364

(22) Filed: Nov. 29, 2017

(51) Int. Cl. G06F 17/30; G09B 5/06

(52) U.S. Cl. CPC G06F 17/3053; G09B 5/06; G06F 17/30528

(57) ABSTRACT

The method, computer program product and computer system may include a computing device that receives at least one course objectives. The computing device may receive a course syllabus which may comprise a plurality of topics and define one or more topic dependencies between the plurality of topics. The computing device may receive an initial class schedule for the plurality of topics. The computing device may receive a student assessment of a first topic on the initial class schedule and may score the assessment of the first topic and select a second topic based on the topic dependencies. The computing device may determine a second assessment score on a second topic using one or more factors. The computing device may determine at least one course schedule option using the at least one course objective, the at least one student assessment score of the first topic, and the second assessment score.

### BACKGROUND

The present invention relates generally to a method, system, and computer program for optimizing course understanding. More particularly, the present invention relates to a method, system, and computer program for optimizing a course schedule based on class-wide topic comprehension.

The goal for course administrators is to achieve the highest level of comprehension of a set of subject-specific topics. Student assessments can be used to test individual student comprehension of specific topics. A course administrator may use the individual student assessments to identify problem areas for a student and to help that individual student. The individual student assessments of an entire class may also be viewed together to gauge the class-wide comprehension of specific topics. A course administrator may use the student assessments to adjust his/her teaching of the course. The above process can be undesirable, for example, at least because the course administrator does not know if re-teaching a topic will be beneficial or time worthy for an entire class.

### BRIEF SUMMARY

An embodiment of the invention may include a method, computer program product and computer system for optimizing course understanding. The method, computer program product and computer system may include computing device that receives at least one course objective from a user device at a server communicating with the user device using a communication network. The computing device may receive a course syllabus at the server, the course syllabus comprising a plurality of topics to be taught and defining one or more topic dependencies between the plurality of topics. The computing device may receive an initial class schedule from a user device at the server for the plurality of topics. The computing device may receive at least one student assessment of a first topic of the plurality of topics on the initial class schedule from the user device. The computing device may score the at least one student assessment of the first topic and select a second topic based on the one or more topic dependencies. The computing device may determine a second assessment score on a second topic, the assessment score on the second topic being determined using one or more factors. The computing device may determine at least one course schedule option, the course schedule option being determined using the at least one course objective, the at least one student assessment score of the first topic, and the second assessment score.

### BRIEF DESCRIPTION OF THE DRAWINGS

FIG. 1 illustrates a system for optimized course understanding, in accordance with an embodiment of the invention;

FIG. 2 illustrates an example topic dependency graph, in accordance with an embodiment of the invention;

FIG. 3a is a flowchart illustrating an example method of optimizing course understanding by a course administrator, in accordance with an embodiment of the invention;

FIG. 3b is a flowchart illustrating an example method of optimizing course understanding by a computer program, in accordance with an embodiment of the invention;

FIG. 4 is a block diagram depicting the hardware components of the non-linear video navigation system of FIG. 1, in accordance with an embodiment of the invention;

FIG. 5 illustrates a cloud computing environment, in accordance with an embodiment of the invention;

FIG. 6 illustrates a set of functional abstraction layers provided by the cloud computing environment of FIG. 5, in accordance with an embodiment of the invention.

### DETAILED DESCRIPTION

Embodiments of the present invention will now be described in detail with reference to the accompanying Figures.

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

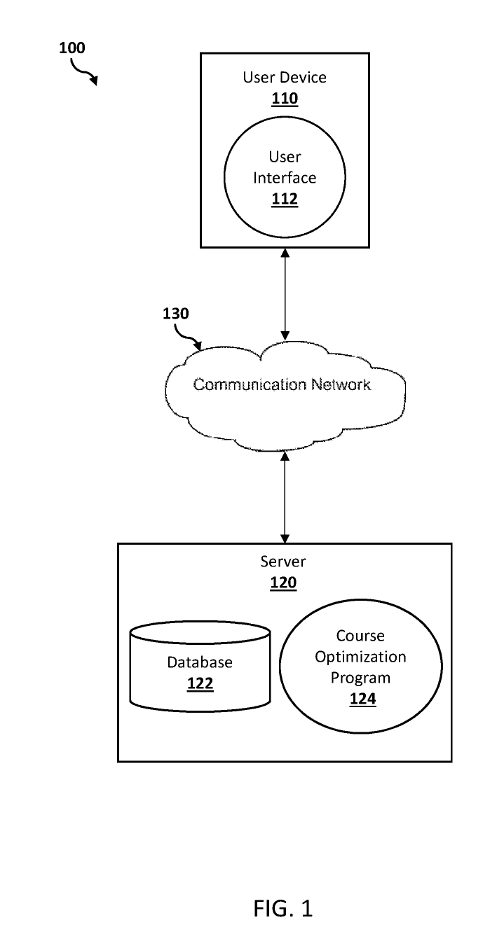

FIG. 1 illustrates a course optimization system 100, in accordance with an embodiment of the invention. In an example embodiment, course optimization system 100 includes a user device 110, and a server 120 interconnected via network 130.

In the example embodiment, network 130 is the Internet, representing a worldwide collection of networks and gateways to support communications between devices connected to the Internet. Network 130 may include, for example, wired, wireless or fiber optic connections. In other embodiments, network 130 may be implemented as an intranet, a local area network (LAN), or a wide area network (WAN). In general, network 130 can be any combination of connections and protocols that will support communications between user device 110 and server 120.

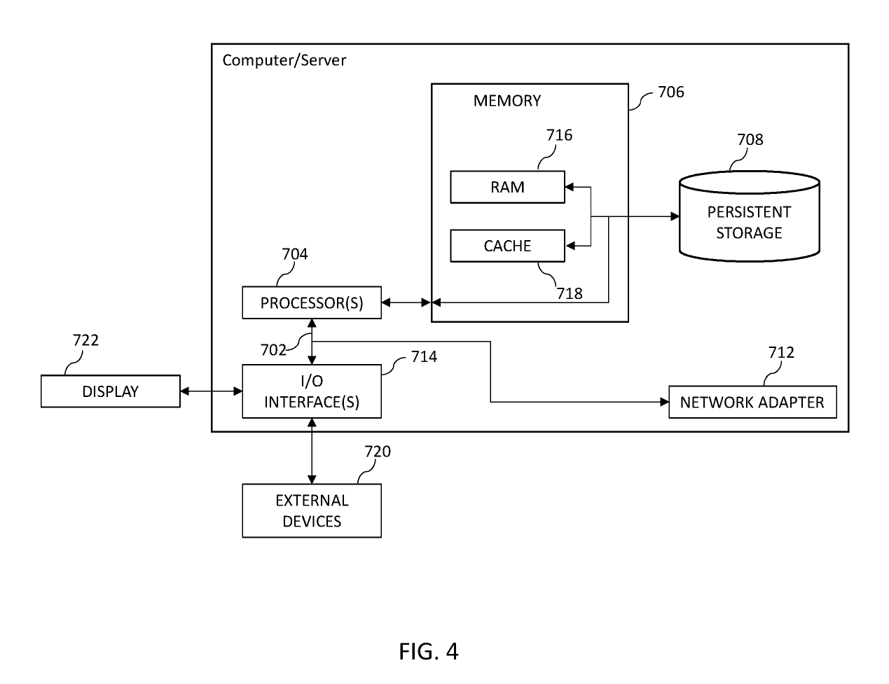

User device 110 may include user interface 112, for example, a graphical user interface. User device 110 may be a desktop computer, a notebook, a laptop computer, a tablet computer, a handheld device, a smart-phone, a cellular phone, a landline phone, a thin client, or any other electronic device, computing system, wired or wireless device capable of receiving and sending content to and from other computing devices, such as server 120, via network 130. Further, course optimization system 100 may include one or more user devices. User device 110 is described in more detail with reference to FIG. 4.

User interface 112 includes components used to receive input from a user on user device 110 and transmit the input to course optimization program 124 residing on server 120, or conversely to receive information from course optimization program 124 and display the information to the user on user device 110. In an example embodiment, user interface 112 uses a combination of technologies and devices, such as device drivers, to provide a platform to enable users of user device 110 to interact with course optimization program 124. In the example embodiment, user interface 112 receives input, such as textual input received from a physical input device, such as a keyboard.

Server 120 includes course optimization program 124 and database 122. In the example embodiment, Server 120 may be a desktop computer, a notebook, a laptop computer, a tablet computer, a thin client, or any other electronic device or computing system capable of storing compiling and organizing audio, visual, or textual content and receiving and sending that content to and from other computing devices, such as user device 110, via network 130. In an example embodiment, server 120 may be resident in user device 110. Server 120 is described in more detail with reference to FIG. 4.

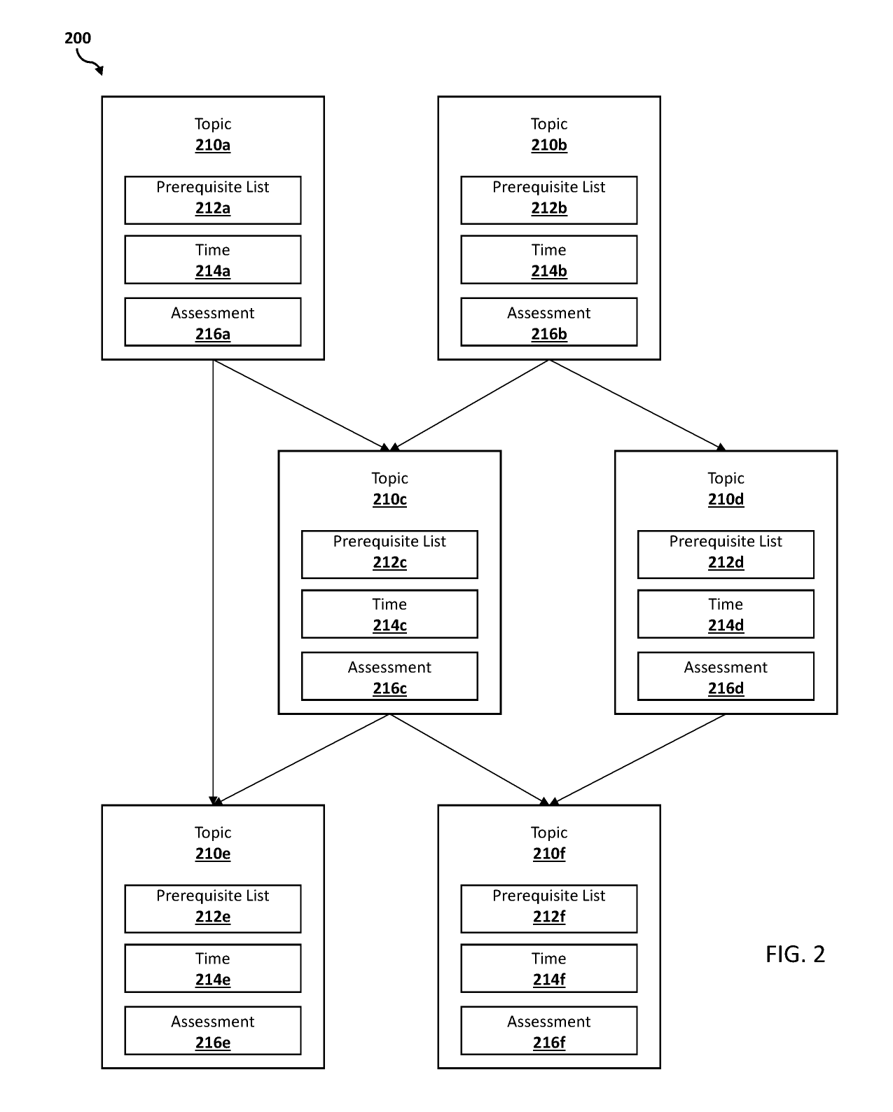

Database 122 may include a collection of course objectives, course syllabi, course schedules, and student assessments received from user device 110. Further, database 122 may include a collection of course optimization results computed using course optimization program 124 on server 120. Course objectives are broad goals set by a course administrator such as, but not limited to, a teacher, a school department head, a school board, a professional organization, a committee, etc. Example course objectives may include, but are not limited to, maximizing the average understanding of an entire class for a whole course, maximizing the number of topics understood by a class with a minimal understanding threshold, i.e. a minimal average test score, maximizing the number of students in a class achieving a high threshold of understanding, i.e. a maximal average test score, and minimizing the number of students in a class with a minimal threshold of understanding, etc. In may be appreciated that one or more course objectives may not be compatible with one another would not be combined. Course syllabi may be outlines of topics to be covered in a course, such as, but not limited to, educational courses, and professional training courses, etc. Course syllabi may be organized into a graph of topics by a course administrator. A course graph may be arranged according to the dependencies, i.e. relationships, between the topics of the course. Course graphs are described in more detail with reference to FIG. 2 below. Course schedules may be timelines, i.e. plans, for teaching the topics outlined in the course graphs. Course schedules may be computed by a course administrator using conventional course scheduling/planning techniques. Student assessments may be any means of evaluating a student's comprehension of a topic, such as, but not limited to, a test, a quiz, a series of multiple choice questions, etc., resulting in a score for each student. Each topic outlined in a course syllabus may be associated with a student assessment. In an embodiment of the invention, a single student assessment may be associated with several topics, depending on the breadth of the topic and testability of that topic.

Course optimization program 124 is a program capable of analyzing course objectives, course syllabi, course schedules, and student assessments received from user device 110 and providing course scheduling options to a course administrator to better achieve a course objective(s).

FIG. 2 is a diagram illustrating an example course graph 200, in accordance with an embodiment of the invention.

Course graph 200 may comprise one or more topics to be taught in a course, such as topics 210a-f. Topics 210a-f in course graph 200 may include prerequisite list 212a-f. Prerequisite List 212 may be a list of topics students need to know before topic 210 is taught. Prerequisite List 212 may also define the dependencies, i.e. relationships, between topics 210a-f. The topic dependencies may define how much a topic relies on a previous topic. For example, Topic 210c may require a student to know Topics 210a-b. The topic dependency may also assign a weight, such as, but not limited to, a dependency factor between 0 and 1, to each prerequisite topic. In the above example, Topic 210c may depend 60% on Topic 210a and 40% on Topic 210b and thus the dependency factors for topic 210c would be 0.6 for topic 210a and 0.4 for topic 210b. These dependency factors may be considered by course optimization program 124 when analyzing course objectives, course syllabi, course schedules, and student assessments received from user device 110 and providing course scheduling options to a course administrator to better achieve a course objective(s). Topics 210a-f may also include an estimated teaching time 214a-f. Further, topics 210a-f may include student assessments 216a-f. While FIG. 2 illustrates six topics, it can be appreciated that course graph 200 may comprise less than six topics or more than six topics.

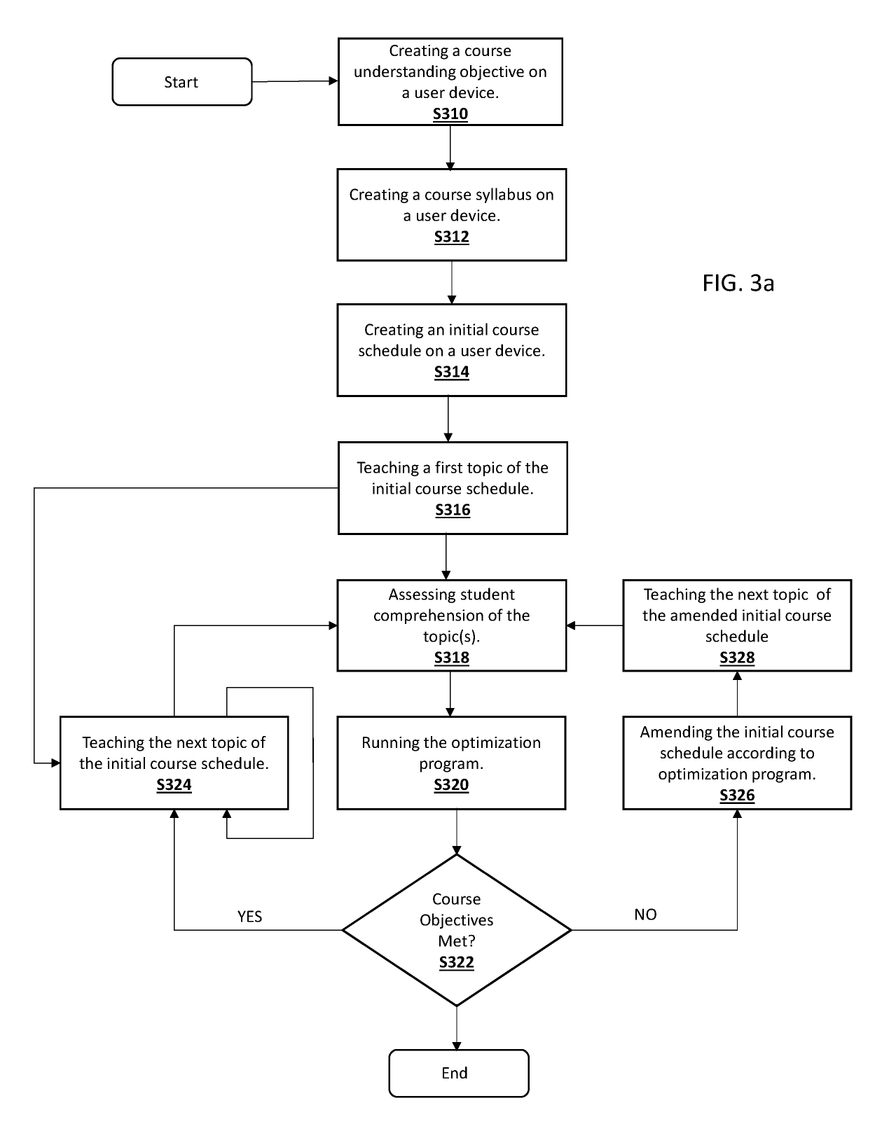

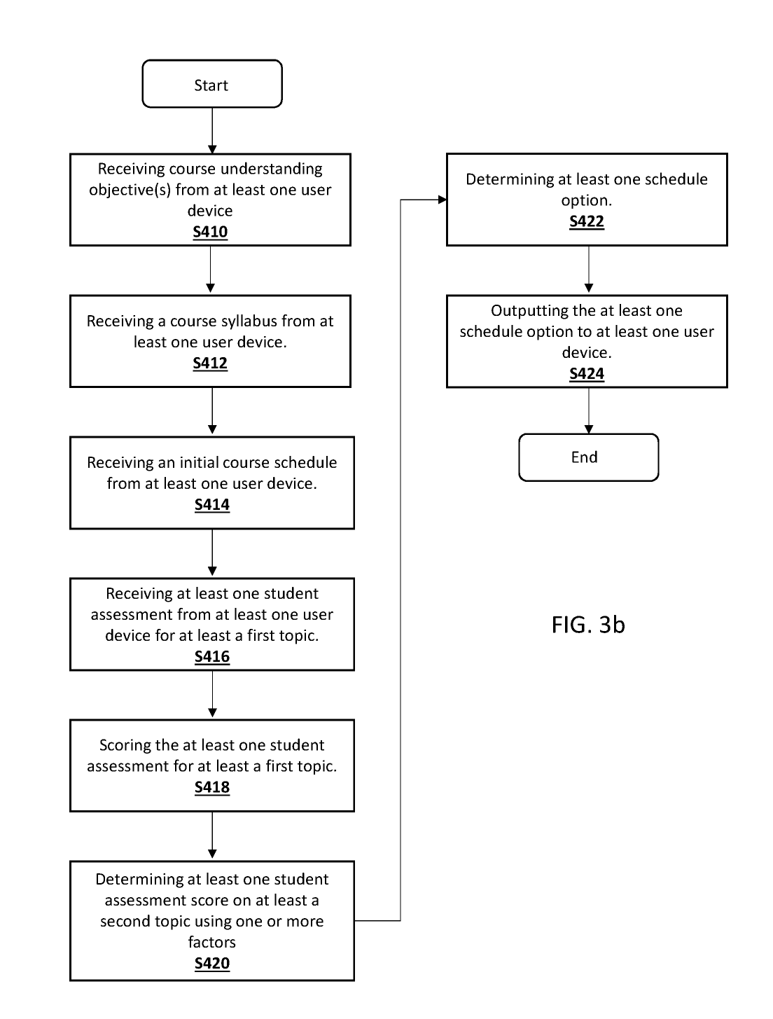

FIG. 3a is a flowchart illustrating a method for course optimization, in accordance with an embodiment of the invention.

Referring to step S310, a course administrator creates one or more course understanding objective(s). A course administrator may create the course understanding objective(s) on user device 110. In an alternate embodiment, a course administrator may create the course understanding objective(s) manually and enter them on user device 110.

Referring to step S312, a course administrator creates a course syllabus. A course administrator may create the course syllabus on user device 110. In an alternate embodiment, a course administrator may create the course syllabus manually and enter them on user device 110.

Referring to step S314, a course administrator creates an initial course schedule. A course administrator may create the initial course schedule on user device 110. In an alternate embodiment, a course administrator may create the initial course schedule manually and enter them on user device 110.

Referring to step S316, a course administrator teaches the first topic of the initial course schedule to a class. After teaching the first topic of the initial course schedule, the course administrator may proceed by assessing the class comprehension at step S318 or by teaching the next topic at step S324.

Referring to step 318, a course administrator assesses student comprehension of the topic taught at step S316. The student assessment may be administered on user device 110. In another embodiment of the invention, the student assessment may be administered on paper and input into user device 110. In yet another embodiment of the inventions, a course administrator may not assess student comprehension of the topic previously taught and move on to step S324 and teach the next topic of the initial course schedule.

Referring to step S320, a course administrator runs course optimization program 124. Course optimization program 124 is described in more detail with reference to FIG. 3b.

Referring to step S322, a course administrator analyzes the results produced by course optimization program 124. Course optimization program 124 may present several options to a course administrator, including but not limited to, that the course objective(s) have been met or the course objective(s) have not been met. For example, course optimization program 124 may present a recommendation such as, but not limited to, “if you want to maximize the number of students with a global assessment score greater than 0.8, you should teach topic 210x” or “if you want to maximize the global average assessment score of the whole classroom, you should re-teach topic 210x”.

Referring to step S324, if a course administrator determines that the course objective(s) have been met for the topic previously taught, a course administrator teaches the next topic of the initial course schedule to a class. In another embodiment of the invention a course administrator may teach the next topic at step S324 after teaching the first topic at step S316. A course administrator may then proceed to step S318 to assess the class comprehension or may proceed to the next topic in the initial course schedule until a student assessment is indicated.

Referring to step S326, if a course administrator determines that the course objective(s) have not been met for the topic previously taught, a course administrator may amend the initial course schedule as suggested by course optimization program 124. For example, a course administrator may amend the initial course schedule to re-teach a topic, which may result in at least one topic being removed from the initial course schedule.

Referring to step S328, a course administrator teaches the next topic of the amended initial course schedule to a class. After teaching the next topic of the amended initial course schedule, the course administrator may proceed by assessing the class comprehension at step S318 or by teaching the next topic at step S324.

A course administrator proceeds through steps S318 to S328 until all topics on the initial course schedule or the amended course schedule are taught.

FIG. 3b is a flowchart illustrating course optimization program 124 of FIG. 3a, in accordance with the invention.

Referring to step S410, course optimization program 124 receives the course understanding objective(s) from user device 110. In another embodiment, course optimization program 124 may receive the course understanding objective(s) from database 122.

Referring to step S412, course optimization program 124 receives the course syllabus from user device 110. In another embodiment, course optimization program 124 may receive the course syllabus from database 122.

Referring to step S414, course optimization program 124 receives the initial course schedule from user device 110. In another embodiment, course optimization program 124 may receive the initial course schedule from database 122.

Referring to step S416, course optimization program 124 receives the course understanding objective(s) from user device 110. In another embodiment, course optimization program 124 may receive the course understanding objective(s) from database 122.

Referring to step S418, course optimization program 124 calculates scores for student assessments received from user device 110. In another embodiment, course optimization program 124 calculates scores for student assessments received from database 122. For example, course optimization program 124 may score the individual students' assessments on a scale from 0 to 1. In the preceding example, if a student scores a 60% on his/her assessment, the assessment would be scored a 0.6.

Referring to step S420 course optimization program 124 calculates topic score predictions based on topic dependencies and student assessment scores. Once a student's individual assessment for a topic has been scored, course optimization program 124 may utilize the dependency factors from the course syllabus to predict that student's success on other related topics in the course syllabus by multiplying the dependency factor and the student assessment score. For example, a topic C may have a dependency factor of 0.6 on a topic A and a dependency factor of 0.4 on a topic B. A student may receive a score of 0.4 on his/her assessment of topic A and a score of 0.5 on his/her assessment on topic B. Thus, course optimization program 124 may calculate the how the student will do on topic C by multiplying the assessment score for each topic by the dependency factor and adding them together: (0.6×0.4)+(0.4×0.5)=0.44. In another embodiment of the invention, course optimization program 124 may calculate topic score predictions if a previous topic is re-taught based on topic dependencies, student assessment scores, and a predefined learning factor. The predefined learning factor is the factor by which the average student's assessment score increases from a first teaching of a topic to a second teaching of the same topic. The predefined learning factor may be input by the course administrator on user device 110. Continuing the example above, a course administrator may determine that the predefined learning factor for topic A is 0.2 if topic A is taught again. Thus, course optimization program 124 may calculate a topic score prediction for topic C if topic A is re-taught by adding 0.2 to the student's original topic A assessment score. Alternatively, the predefined learning factor may be determined by course optimization program 124 by analyzing student assessment scores from repeated topics over time and averaging the score differences.

Referring to step S422, course optimization program 124 calculates course schedule options based on the understanding objective(s), course syllabus, initial course schedule, and student assessments received from user device 110. In another embodiment, course optimization program 124 calculates course schedule options based on the understanding objective(s), course syllabus, initial course schedule, and student assessments 216 received from database 122. For example, course optimization program 124 may determine that all students have met the threshold defined in the understanding objective(s) and would determine that a course administrator should teach the next scheduled topic in the initial course schedule. In another example, course optimization program 124 may determine that the average student assessment score for a particular topic did not meet the threshold defined in the understanding objective(s) and would determine that the topic should be re-taught. Further, course optimization program 124 may take into account the amount of time remaining in the initial course schedule to calculate course schedule options. For example, course optimization program 124 may determine that a topic should be re-taught; however, there may not be enough time in the overall course to cover all the important topics and thus re-teaching the topic may not be possible. Alternatively, if a topic if course optimization program 124 determines a topic should be re-taught, course optimization program 124 may analyze the remaining topics of the initial course schedule and recommend deleting one or more topics based on their importance to the overall course and course objective(s). The importance of any single topic may be determined by analyzing the topic dependencies. For example, referring to FIG. 2, topic 210f depends on topics 210c and 210d, but there are no topics that depend from topic 210f. Therefore, if course optimization program 124 determine that any one of topics 210a-e need to be re-taught, course optimization program 124 may recommend that topic 210f be deleted from the initial course schedule.

Referring to step S424, course optimization program 124 presents a course administrator with course schedule options determined at step S422. The course administrator may then proceed as discussed above in FIG. 3a.

FIG. 4 depicts a block diagram of components of user device 110 and server 120, in accordance with an illustrative embodiment of the present invention. It should be appreciated that FIG. 4 provides only an illustration of one implementation and does not imply any limitations with regard to the environments in which different embodiments may be implemented. Many modifications to the depicted environment may be made.

User device 110 and server 120 may include communications fabric 702, which provides communications between computer processor(s) 704, memory 706, persistent storage 708, communications unit 712, and input/output (I/O) interface(s) 714. Communications fabric 702 can be implemented with any architecture designed for passing data and/or control information between processors (such as microprocessors, communications and network processors, etc.), system memory, peripheral devices, and any other hardware components within a system. For example, communications fabric 702 can be implemented with one or more buses.

Memory 706 and persistent storage 708 are computer-readable storage media. In this embodiment, memory 706 includes random access memory (RAM) 716 and cache memory 718. In general, memory 706 can include any suitable volatile or non-volatile computer-readable storage media.

The programs course optimization program 124 and database 122 in server 120; and user interface 112 stored in user device 110 are stored in persistent storage 708 for execution by one or more of the respective computer processors 704 via one or more memories of memory 706. In this embodiment, persistent storage 708 includes a magnetic hard disk drive. Alternatively, or in addition to a magnetic hard disk drive, persistent storage 708 can include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 708 may also be removable. For example, a removable hard drive may be used for persistent storage 708. Other examples include optical and magnetic disks, thumb drives, and smart cards that are inserted into a drive for transfer onto another computer-readable storage medium that is also part of persistent storage 708.

Communications unit 712, in these examples, provides for communications with other data processing systems or devices. In these examples, communications unit 712 includes one or more network interface cards. Communications unit 712 may provide communications through the use of either or both physical and wireless communications links. The programs course optimization program 124 and database 122 in server 120; and user interface 112 stored in user device 110 may be downloaded to persistent storage 708 through communications unit 712.

I/O interface(s) 714 allows for input and output of data with other devices that may be connected to server 120, and user device 110. For example, I/O interface 714 may provide a connection to external devices 720 such as a keyboard, keypad, a touch screen, and/or some other suitable input device. External devices 720 can also include portable computer-readable storage media such as, for example, thumb drives, portable optical or magnetic disks, and memory cards. Software and data used to practice embodiments of the present invention, e.g., the programs course optimization program 124 and database 122 in server 120; and user interface 112 stored in user device 110, can be stored on such portable computer-readable storage media and can be loaded onto persistent storage 708 via I/O interface(s) 714. I/O interface(s) 714 can also connect to a display 722.

Display 722 provides a mechanism to display data to a user and may be, for example, a computer monitor.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

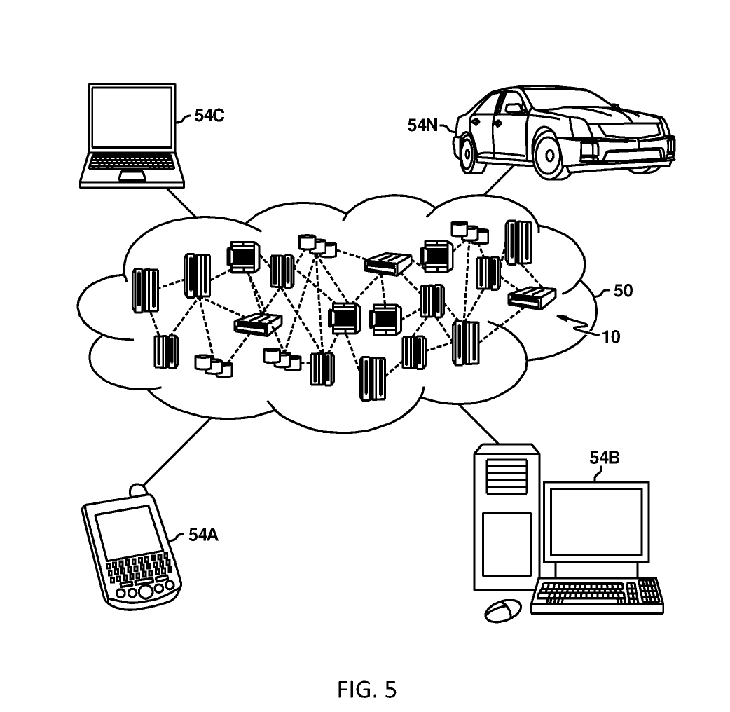

Referring now to FIG. 5, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 9 are intended to be illustrative only and that computing nodes 10 and cloud computing environment 50 can communicate with any type of computerized device over any type of network and/or network addressable connection (e.g., using a web browser).

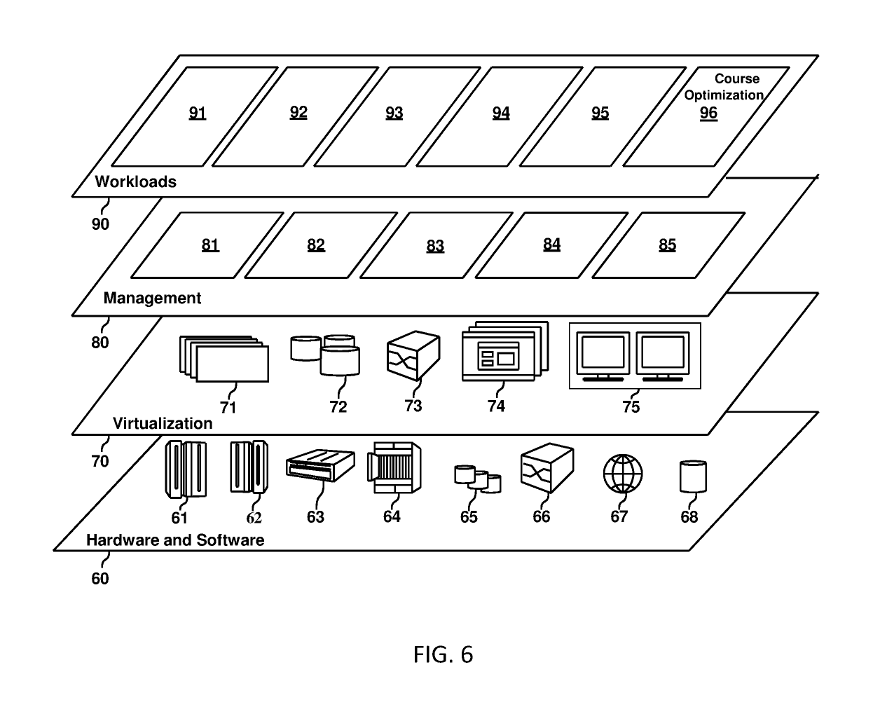

Referring now to FIG. 6, a set of functional abstraction layers provided by cloud computing environment 50 (FIG. 5) is shown. It should be understood in advance that the components, layers, and functions shown in FIG. 10 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and course optimization 96.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While steps of the disclosed method and components of the disclosed systems and environments have been sequentially or serially identified using numbers and letters, such numbering or lettering is not an indication that such steps must be performed in the order recited, and is merely provided to facilitate clear referencing of the method's steps. Furthermore, steps of the method may be performed in parallel to perform their described functionality.

What is claimed is:

1. A method for optimizing course understanding, the method comprising:
receiving at least one course objective from at least one user device at a server communicating with the user device using a communication network;
receiving a course syllabus at the server, the course syllabus comprising a plurality of topics to be taught and defining one or more topic dependency between the plurality of topics;
receiving an initial class schedule from the at least one user device at the server for the plurality of topics;
receiving at least one student assessment of a first topic of the plurality of topics on the initial class schedule from the at least one user device;
scoring the at least one student assessment of the first topic;
selecting a second topic based on the one or more topic dependencies;
determining a second assessment score on a second topic, the assessment score on the second topic being determined using one or more factors; and
determining at least one course schedule option, the course schedule option being determined using the at least one course objective, the at least one student assessment score of the first topic, and the second assessment score.

2. A method as in claim 1, wherein the student assessment score on the second topic is determined based on the student assessment score on the first topic and the topic dependency between the first and second topic.

3. A method as in claim 1, wherein the topic dependency between a first topic of the plurality of topics and a second topic of the plurality of topics is defined on a scale from 0 to 1.

4. A method as in claim 1, wherein the course schedule option amends the initial class schedule to re-teach the first topic of the plurality of topics.

5. A method as in claim 1, wherein the course schedule option amends the initial class schedule by removing one of the plurality of topics from the initial class schedule.

6. A method as in claim 1, wherein the assessment of student comprehension is based on multiple choice questions.

7. A method as in claim 1, wherein the at least one course objective is defined for two or more students.

8. A computer program product for optimizing course understanding, the computer program product comprising:
a computer-readable storage device and program instructions stored on computer-readable storage device, the program instructions comprising:
program instructions to receive at least one course objective from at least one user device at a server communicating with the user device using a communication network;
program instructions to receive a course syllabus at the server, the course syllabus comprising a plurality of topics to be taught and defining one or more topic dependency between the plurality of topics;
program instructions to receive an initial class schedule from the at least one user device at the server for the plurality of topics;
program instructions to receive at least one student assessment of a first topic of the plurality of topics on the initial class schedule from the at least one user device;
program instructions to score the at least one student assessment of the first topic;
program instructions to select a second topic based on the one or more topic dependencies;
program instructions to determine a second assessment score on a second topic, the assessment score on the second topic being determined using one or more factors; and
program instructions to determine at least one course schedule option, the course schedule option being determined using the at least one course objective, the at least one student assessment score of the first topic, and the second assessment score.

9. A computer program product as in claim 8, wherein the student assessment score on the second topic is determined based on the student assessment score on the first topic and the topic dependency between the first and second topic.

10. A computer program product as in claim 8, wherein the topic dependency between a first topic of the plurality of topics and a second topic of the plurality of topics is defined on a scale from 0 to 1.

11. A computer program product as in claim 8, wherein the course schedule option amends the initial class schedule to re-teach the first topic of the plurality of topics.

12. A computer program product as in claim 8, wherein the course schedule option amends the initial class schedule by removing one of the plurality of topics from the initial class schedule.

13. A computer program product as in claim 8, wherein the assessment of student comprehension is based on multiple choice questions.

14. A computer program product as in claim 8, wherein the at least one course objective is defined for two or more students.

15. A computer system for optimizing course understanding, the computer system comprising:
one or more processors, one or more computer-readable memories, one or more computer-readable tangible storage devices, and program instructions stored on at least one of the one or more storage devices for execution by at least one of the one or more processors via at least one of the one or more memories, the program instructions comprising:
program instructions to receive at least one course objective from at least one user device at a server communicating with the user device using a communication network;
program instructions to receive a course syllabus at the server, the course syllabus comprising a plurality of topics to be taught and defining one or more topic dependency between the plurality of topics;
program instructions to receive an initial class schedule from the at least one user device at the server for the plurality of topics;
program instructions to receive at least one student assessment of a first topic of the plurality of topics on the initial class schedule from the at least one user device;
program instructions to score the at least one student assessment of the first topic;
program instructions to select a second topic based on the one or more topic dependencies;
program instructions to determine a second assessment score on a second topic, the assessment score on the second topic being determined using one or more factors; and
program instructions to determine at least one course schedule option, the course schedule option being determined using the at least one course objective, the at least one student assessment score of the first topic, and the second assessment score.

16. A computer system as in claim 15, wherein the student assessment score on the second topic is determined based on the student assessment score on the first topic and the topic dependency between the first and second topic.

17. A computer system as in claim 15, wherein the topic dependency between a first topic of the plurality of topics and a second topic of the plurality of topics is defined on a scale from 0 to 1.

18. A computer system as in claim 15, wherein the course schedule option amends the initial class schedule to re-teach the first topic of the plurality of topics.

19. A computer system as in claim 15, wherein the course schedule option amends the initial class schedule by removing one of the plurality of topics from the initial class schedule.

20. A computer system as in claim 15, wherein the assessment of student comprehension is based on multiple choice questions.
